(19) United States
(12) Patent Application Publication
(10) Pub. No.: US 2012/0165984 A1
(43) Pub. Date: Jun. 28, 2012

(54) MOBILE ROBOT APPARATUS, DOOR CONTROL APPARATUS, AND DOOR OPENING AND CLOSING METHOD THEREFOR

(75) Inventors: Sang Seung KANG, Daejeon (KR); Jae Hong KIM, Daejeon (KR); Joo Chan SOHN, Daejeon (KR); Chan Kyu PARK, Daejeon (KR)

(73) Assignee: Electronics and Telecommunications Research Institute, Daejeon (KR)

(21) Appl. No.: 13/324,038

(22) Filed: Dec. 13, 2011

(30) Foreign Application Priority Data
Dec. 23, 2010 (KR) 10-2010-0133405

(51) Int. Cl. B25J 13/08; B25J 19/04

(52) U.S. Cl. 700/259; 901/47; 901/9

(57) ABSTRACT

A mobile robot apparatus includes a video recognition unit for recognizing a position of an opening button mounted around a door through video analysis after acquiring peripheral video information. Further, the mobile robot apparatus includes a mobile controller for performing an operation on the opening button at the position recognized by the video recognition unit to generate an opening selection signal, thereby allowing a door control apparatus to open the door according to the generated opening selection signal.

### CROSS-REFERENCE TO RELATED APPLICATION(S)

The present invention claims priority of Korean Patent Application No. 10-2010-0133405, filed on Dec. 23, 2010, which is incorporated herein by reference.

### FIELD OF THE INVENTION

The present invention relates to a door opening method for a mobile robot; and more particularly, to a mobile robot apparatus for enabling a mobile robot to go in and out a door by opening and closing a door based on interaction with a door control apparatus so that the mobile robot moves from a space to another space, a door control apparatus, and a door opening method therefor.

### BACKGROUND OF THE INVENTION

As well known in the art, a demand for a robot conveniently and naturally providing services to human has been increased. For moving the robot within a space, the traveling of the robot is a necessary factor. To this end, various researches, such as a driving method, a method for recognizing a movement of the robot between spaces, or the like, have been conducted.

In order for the robot to move from a space to another space by passing through the door, the robot needs to be implemented to turn a door handle and open the door like human and move to another space and then, close the door again. The mobile robot apparatus is provided with at least one arm apparatus. The mobile robot apparatus recognizes the door handle and then, drives the arm apparatus to pull or push the door by turning the door handle to slowly open the door. Thereafter, when the mobile robot apparatus confirms the opened state, the mobile robot apparatus moves and passes through the door. In addition, the mobile robot apparatus is further provided with a mechanism that allows the mobile robot apparatus to enter another space by passing through the door and then, close the door again.

However, the related art failed to present a clear solution due to the difficulty in implementing a technology that opens and closes the door by allowing the robot to operate the arm apparatus to turn the door handle, even though many researches for the mobile robot to open and close the door have been conducted.

Recently, an automatic door system for an old and feeble person or the disabled person having difficulty in opening and closing the door by turning a general door handle has been introduced. When a person positioned in front of the door is detected using a distance sensor, a body sensing sensor, or the like, a system for automatically opening and closing the door, or the like, is generally used. However, when a person is positioned in front of the door, the system leads to the unnecessary opening and closing of the door, regardless of the person's intention to open the door.

As one of methods for supplementing the automatic door system, a system for automatically opening and closing the door that an opening button is disposed beside the automatic door so that a person's hand can easily get at the opening button has been introduced, the door being automatically opened when the opening button is pressed. Therefore, there exists a need for a technology of enabling a robot to go in and out the door by opening and closing the door under the conditions. In addition, there exists a need for a realistically applicable technology by more easily solving the technical difficulties in recognizing and controlling the door handle or the opening button using a video measurement system or a plurality of sensor systems.

### SUMMARY OF THE INVENTION

In view of the above, the present invention provides a mobile robot apparatus enabling a mobile robot to go in and out a door by easily opening and closing the door based on interaction with a door control apparatus, a door control apparatus supporting a door opening and closing method, and a door opening and closing method by the mobile robot apparatus and the door control apparatus.

In accordance with a first aspect of the present invention, there is provided a mobile robot apparatus, including: a video recognition unit for recognizing a position of an opening button mounted around a door through video analysis after acquiring peripheral video information; and a mobile controller for performing an operation on the opening button at the position recognized by the video recognition unit to generate an opening selection signal, thereby allowing a door control apparatus to open the door according to the generated opening selection signal.

In accordance with a second aspect of the present invention, there is provided a door control apparatus, including: a wireless communication unit for receiving an opening selection signal transmitted by a mobile robot apparatus; and an opening and closing controller for opening a door according to the opening selection signal received by the wireless communication unit.

In accordance with a third aspect of the present invention, there is provided a door control apparatus, including: a video recognition unit for recognizing a mobile robot apparatus by acquiring peripheral video information and then, analyzing the video; and an opening and closing controller for opening the door when the video recognition unit recognizes the mobile robot apparatus.

In accordance with a fourth aspect of the present invention, there is provided a door opening and closing method of a mobile robot apparatus, including: recognizing a position of an opening button mounted around a door through video analysis after acquiring peripheral video information; and performing an operation on the opening button at the recognized position to generate an opening selection signal, thereby allowing a door control apparatus to open the door according to the generated opening selection signal.

In accordance with a fifth aspect of the present invention, there is provided a door opening and closing method of a door control apparatus, including: recognizing a mobile robot apparatus by allowing the mobile robot apparatus to receive a transmitted opening selection signal or acquire peripheral video information and then, analyzing the video; and opening the door according to the opening selection signal or the recognition of the mobile robot apparatus.

In accordance with an embodiment of the present invention, there can be provided the realistic and efficient alternative plans for the door opening and closing method of a robot by the door handle operation in accordance with the related art that does not present a clear solution due to the technical difficulties, by easily opening and closing the door based on the interaction between the mobile robot apparatus and the door control apparatus.

In addition, the exemplary embodiments of the present invention can originally use the original or partially expanded mobile robot apparatus or door control apparatus in accordance with the related art and can be implemented to meet the operation environments or the policies by using any one or combining at least one of various types of door opening and closing methods for moving the robot.

### BRIEF DESCRIPTION OF THE DRAWINGS

The objects and features of the present invention will become apparent from the following description of embodiments given in conjunction with the accompanying drawings, in which:

FIG. 1 is a diagram illustrating a mobile robot apparatus and an operation environment thereof to which a door opening and closing method in accordance with an embodiment of the present invention can be applied;

FIG. 2 is a block configuration diagram illustrating the mobile robot apparatus and a door control apparatus to which the door opening and closing method in accordance with the embodiment of the present invention can be applied;

FIG. 3 is a flow chart for explaining a door opening and closing method in accordance with a first embodiment of the present invention;

FIG. 4 is a flow chart for explaining a door opening and closing method in accordance with a second embodiment of the present invention; and

FIG. 5 is a flow chart for explaining a door opening and closing method in accordance with a third embodiment of the present invention.

### DETAILED DESCRIPTION OF THE EMBODIMENTS

Embodiments of the present invention will be described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

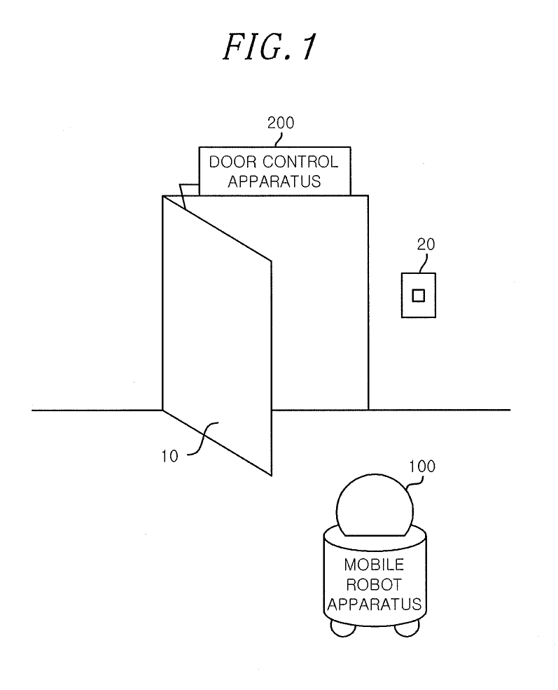

FIG. 1 is a diagram illustrating a mobile robot apparatus and an operation environment thereof to which a door opening and closing method in accordance with an embodiment of the present invention can be applied.

Referring to FIG. 1, the embodiment of the present invention may be applied to an operation environment including a mobile robot apparatus 100 and a door control apparatus 200 and may also be applied to an operation environment in which an opening button 20 capable of selecting an opening of a door 10 is mounted around the door 10.

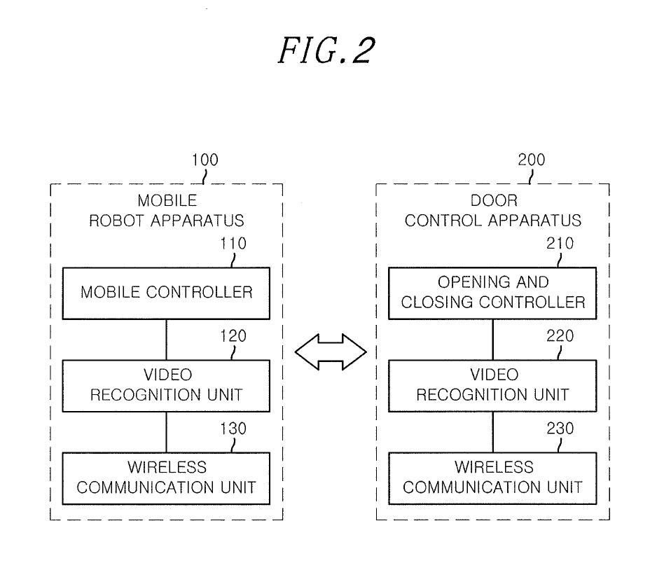

FIG. 2 is a block configuration diagram illustrating the mobile robot apparatus and the door control apparatus to which the door opening and closing method in accordance with the embodiment of the present invention can be applied.

As illustrated in FIG. 2, in accordance with the embodiment of the present invention, the mobile robot apparatus 100 includes a mobile controller 110, a video recognition unit 120, a wireless communication unit 130, and the like, and the door control apparatus 200 includes an opening and closing controller 210, a video recognition unit 220, a wireless communication unit 230, and the like. The mobile robot apparatus 100 and the door control apparatus 200 may be implemented to include all components described above and may also be implemented to selectively include components required to perform the door opening and closing method in accordance with the embodiment to be described below.

Referring to FIGS. 1 and 2, the video recognition unit 120 of the mobile robot apparatus 100 acquires the peripheral video information and then recognizes the position of the opening button 20 mounted around the door 10 through the video analysis.

The mobile controller 110 of the mobile robot apparatus 100 operates the arm apparatus to perform the operation such as pressing the opening button 20 mounted around the door 10, thereby generating an opening selection signal.

The wireless communication unit 130 of the mobile robot apparatus 100 transmits the opening selection signal to the door control apparatus 200.

The wireless communication unit 230 of the door control apparatus 200 receives the opening selection signal from the mobile robot apparatus 100.

The video recognition unit 220 of the door control apparatus 200 acquires the peripheral video information and then, recognizes the mobile robot apparatus 100 through the video analysis.

The opening and closing controller 210 of the door control apparatus 200 operates the door opening and closing apparatus, or the like, according to the opening selection signal according to the operation of the opening button 20 by the mobile robot apparatus 100 to open the door 10 and close the door 10 again when satisfying the predetermined conditions (for example, when the predetermined time lapses after the opening).

Alternatively, the opening and closing controller 210 of the door control apparatus 200 analyzes the opening selection signal received by the wireless communication unit 230 to confirm whether the admission of the mobile robot is permitted, operates the door opening and closing apparatus, or the like, to open the door 10 if it is determined to be the mobile robot admitted to the door 10, and close the door 10 again when satisfying the predetermined conditions (for example, when the predetermined time lapses after the opening).

Alternatively, the opening and closing controller 210 of the door control apparatus 200 confirms whether the admission of the mobile robot is permitted when the video recognition unit 220 acquires the peripheral video information and then recognizes the mobile robot apparatus 100 through the video analysis. As a result, if it is determined that the mobile robot is admitted to the door 10, the opening and closing controller 210 opens the door 10 by operating the door opening and closing apparatus, or the like, and closes the door 10 again when satisfying the predetermined conditions (for example, when the predetermined time lapses after the opening).

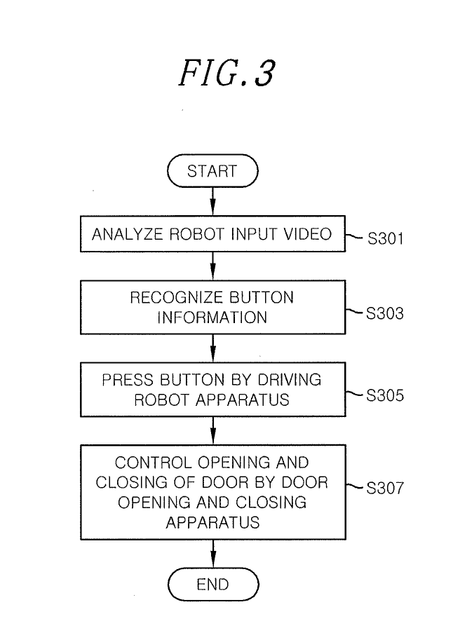

FIG. 3 is a flow chart for explaining a door opening and closing method in accordance with a first embodiment of the present invention. In order to perform the door opening and closing method in accordance with the first embodiment of the present invention, the mobile robot apparatus 100 shown in FIG. 2 essentially includes the mobile controller 110 and the video recognition unit 120 and the door control apparatus 200 essentially includes the opening and closing controller 210.

Referring to FIGS. 1 to 3, the door opening and closing method in accordance with the first embodiment of the present invention includes recognizing the position of the opening button 20 mounted around the door 10 through the video analysis after the video recognition unit 120 of the mobile robot apparatus 100 acquires the peripheral video information in step S301 and S303; generating the opening selection signal by allowing the mobile controller 110 of the mobile robot apparatus 100 to operate the arm apparatus, or the like, to perform the operation such as pressing the opening button 20 of the predetermined position in step S305; opening the door 10 by allowing the opening and closing controller 210 of the door control apparatus 200 to operate the door opening and closing apparatus, or the like, according to the opening selection signal generated by the operation of the opening button 20 in step S307, and the like.

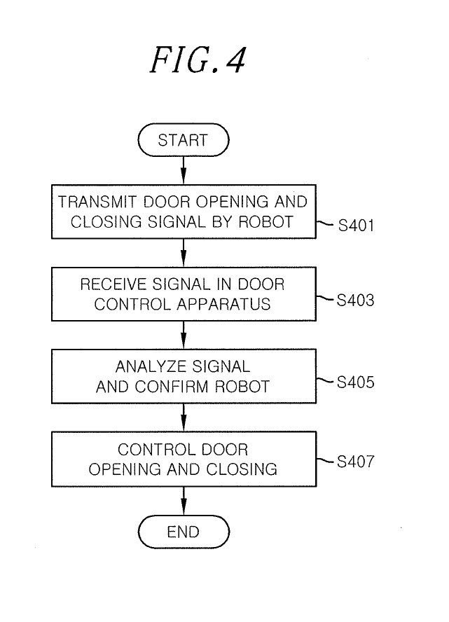

FIG. 4 is a flow chart for explaining a door opening and closing method in accordance with a second embodiment of the present invention. In order to perform of the door opening and closing method in accordance with the second embodiment of the present invention, the mobile robot apparatus 100 of FIG. 2 essentially includes the wireless communication unit 130 and the door control apparatus 200 essentially includes the wireless communication unit 230 and the opening and closing controller 210.

Referring to FIGS. 1, 2, and 4, the door opening and closing method in accordance with the second embodiment of the present invention includes transmitting the opening selection signal by the wireless communication unit 130 of the mobile robot apparatus 100 in step S401; receiving the opening selection signal by the wireless communication unit 230 of the door control apparatus 200 in step S403; confirming whether the admission of the mobile robot is permitted by allowing the opening and closing controller 210 of the door control apparatus 200 to analyze the opening selection signal in step S405, opening the door 10 by allowing the opening and closing controller 210 of the door control apparatus 200 to operate the door opening and closing apparatus, or the like, if it is determined that the mobile robot is admitted to the door 10 in step S407, and the like.

For example, the opening selection signal transmitted from the wireless communication unit 130 of the mobile robot apparatus 100 to the wireless communication unit 230 of the door control apparatus 200 may be infrared signals for simple remote control and may be used by defining a more complicated message standard. That is, the opening selection signal may be configured and applied to be appropriate for the operation environment and the use policy.

Further, whether only the mobile robot admitted to the door 10 opens the door 10 may be determined based on the use policy. In this case, step S405 may be omitted.

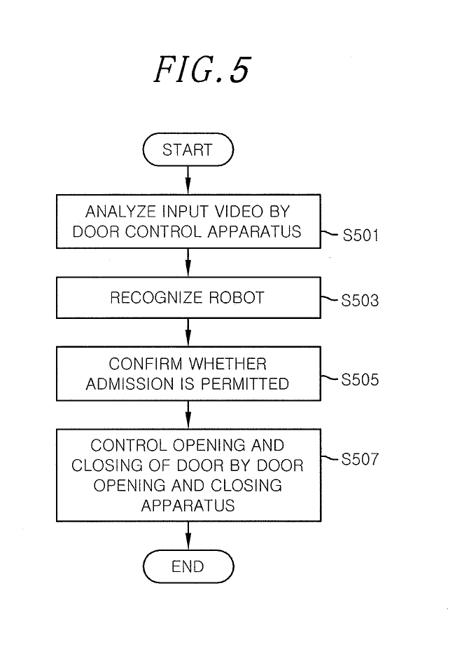

FIG. 5 is a flow chart for explaining a door opening and closing method in accordance with a third embodiment of the present invention. In order to perform the door opening and closing method in accordance with the third embodiment of the present invention, the door control apparatus of FIG. 2 essentially includes the video recognition unit 220 and the opening and closing controller 210.

Referring to FIGS. 1, 2 and 5, the door opening and closing method in accordance with the third embodiment of the present invention includes recognizing the mobile robot apparatus 100 through the video analysis after the video recognition unit 220 of the door control apparatus 200 acquires the peripheral video information in step S501 and step S503; confirming whether the admission of the mobile robot is permitted by the opening and closing controller 210 of the door control apparatus 200 in step S505, and opening the door 10 by allowing the opening and closing controller 210 of the door control apparatus 200 to operate the door opening and closing apparatus, or the like if it is determined that the mobile robot is admitted to the door 10 in step S507, and the like.

For the recognition of the mobile robot apparatus 100, a procedure of previously registering the robot information may be performed. In this case, the door control apparatus 200 may have database for robot registration information. In this case, in step S505 it is confirmed that whether the admission of the mobile robot is permitted, that is, the mobile robot is previously registered by searching the database.

Further, whether only the mobile robot admitted to the door opens the door 10 may be determined based on the use policy. In this case, step S505 may be omitted.

While the invention has been shown and described with respect to the preferred embodiments, it will be understood by those skilled in the art that various changes and modifications may be made without departing from the scope of the invention as defined in the following claims.

What is claimed is:

1. A mobile robot apparatus, comprising:
a video recognition unit for recognizing a position of an opening button mounted around a door through video analysis after acquiring peripheral video information; and
a mobile controller for performing an operation on the opening button at the position recognized by the video recognition unit to generate an opening selection signal, thereby allowing a door control apparatus to open the door according to the generated opening selection signal.

2. A door control apparatus, comprising:
a wireless communication unit for receiving an opening selection signal transmitted by a mobile robot apparatus; and
an opening and closing controller for opening a door according to the opening selection signal received by the wireless communication unit.

3. The door control apparatus of claim 2, wherein the opening and closing controller confirms whether the mobile robot apparatus is a mobile robot admitted to the door by analyzing the opening selection signal and opens the door if it is determined that the mobile robot is admitted to the door.

4. A door control apparatus, comprising:
a video recognition unit for recognizing a mobile robot apparatus by acquiring peripheral video information and then, analyzing the video; and
an opening and closing controller for opening the door when the video recognition unit recognizes the mobile robot apparatus.

5. The door control apparatus of claim 4, wherein the opening and closing controller confirms whether the mobile robot apparatus is a mobile robot admitted to the door and opens the door if it is determined that the mobile robot is admitted to the door.

6. The door control apparatus of claim 4, wherein the opening and closing controller includes database in which information regarding the mobile robots admitted to the door is previously registered and searches the database to confirm whether the admission of the mobile robot is permitted.

7. A door opening and closing method of a mobile robot apparatus, comprising:
recognizing a position of an opening button mounted around a door through video analysis after acquiring peripheral video information; and
performing an operation on the opening button at the recognized position to generate an opening selection signal, thereby allowing a door control apparatus to open the door according to the generated opening selection signal.

8. A door opening and closing method of a door control apparatus, comprising:
recognizing a mobile robot apparatus by allowing the mobile robot apparatus to receive a transmitted opening selection signal or acquire peripheral video information and then, analyzing the video; and
opening the door according to the opening selection signal or the recognition of the mobile robot apparatus.

9. The door opening and closing method of claim 8, wherein said opening the door includes:
confirming whether the mobile robot apparatus is a mobile robot admitted to the door by analyzing the opening selection signal; and
opening the door if it is determined that the mobile robot apparatus is the mobile robot admitted to the door.

10. The door opening and closing method of claim 9, wherein said confirming includes:
previously registering information regarding the mobile robot admitted to the door in database; and
searching the database to confirm whether the mobile robot apparatus is the registered mobile robot.
